(19) United States
(12) Patent Application Publication
(10) Pub. No.: US 2007/0019008 A1
(43) Pub. Date: Jan. 25, 2007

(54) Systems, methods, and programs for increasing print quality

(75) Inventors: Trevor J. Snyder, Newberg, OR (US); David L. Knierim, Wilsonville, OR (US); Stephen M. Kroon, Sherwood, OR (US)

Correspondence Address: OLIFF & BERRIDGE, PLC., P.O. BOX 19928, ALEXANDRIA, VA, 22320, US

(73) Assignee: XEROX CORPORATION, Stamford, CT (US)

(21) Appl. No.: 11/187,008

(22) Filed: Jul. 22, 2005

(51) Int. Cl. B41J 29/38

(52) U.S. Cl. 347/5

(57) ABSTRACT

Systems, methods, and programs for increasing the quality of a marked image determine a marking pattern based on an input image signal, the marking pattern containing at least two sizes of marks, and eject single sized drops of marking material corresponding to a smallest one at least two sizes of marks on an intermediate substrate such that at least two of the single sized drops of marking material coalesce on the intermediate substrate to form another of the at least two sizes of marks.

### BACKGROUND OF THE INVENTION

1. Related Technical Fields

The subject disclosure is generally related to color printing. Related technical fields include systems, methods, and programs for achieving better color saturation, banding, image transfer efficiency, low graininess, and modified marking material properties in a marked image.

2. Description of Related Art

Many conventional marking devices utilize, for example, a fluidic jet driven by a piezoelectric diaphragm to control the ejection of marking material. In this design, a piezoelectric material is bonded to a thin flexible diaphragm that is part of the fluid path of a single jet out of a plurality of jets within a printhead. Electricity is applied to the piezoelectric sheet in a specially designed waveform. This deflects the diaphragm causing the marking material chamber to either expand or contract. The expansion or contraction of the chamber causes the chamber to fill with marking material and/or eject marking material from the jet.

Conventional marking devices, for example, offset solid inkjet printers, may utilize different marking material drop masses. Dual-drop refers to the ability of the printhead to generate two or more different drop masses. However, only one of these masses is used in a given image. The different drop masses are generated using a single geometric marking material jet design and applying a different electrical waveform to the piezoelectric diaphragm. For example, a known marking device uses a 110 ng drop and a 67 ng drop. However, a jet is typically optimized to run at some given dropmass at its maximum operating frequency. In order to achieve a smaller drop with the same jet geometry, the smaller drop waveform typically runs at a lower frequency. Thus, although the drop is smaller, resulting in a greater resolution of the marked image, the marking process is slower. This is true even for those portions of a marked image that did not require high resolution.

Having multiple drop masses available within a given image is advantageous since the larger drops can be used in solid fill regions to increase color saturation and the smaller drops can be used in light fill regions to reduce graininess. Thus, the printer can be optimized for speed and quality that is advantageous to customer needs.

### SUMMARY

There is always a quality/speed consideration that must be made when setting the dropmass of a printer. Large drops are needed in solid fill regions to increase color saturation at lower resolutions that afford higher print speeds, and small drops are needed in light fill regions to reduce graininess.

Marking devices have attempted to use more than one drop size in a single image by using Drop Size Switching (DSS). DSS refers to the ability of a jet to generate a multitude of drop masses (for example, two) on the fly. This can be accomplished by fitting two half-length (½) waveforms into the jetting time 1/fop. Here “fop” refers to “frequency of operation,” which is the frequency at which drops eject from each jet of a print head when firing continuously. One of the two waveforms is selected according to one or more patterning methodologies to print a page length document. This achieves printing from individual jet nozzles of either a large drop or a small drop.

Unfortunately, there are other drawbacks to switching drop size in this way. Most important, for example, is the fact that the two waveforms must be small enough to fit within the same time interval (1/fop). This is particularly problematic as the jetting frequency (overall marking speed) is continually increased to meet market demand. The use of multiple waveforms typically slows the jetting frequency, and thus overall marking speed.

Accordingly, it is beneficial to utilize multiple drop masses, while maintaining waveforms with substantially the same time interval.

Multiple drop masses (sizes) may be created by using a single mass (size) drop ejected at very high frequency. The placement of the single mass drops may be varied in such a manner that one or more of the small drops may coalesce on an intermediate substrate within the marking device in order to form larger drops. Because only one drop mass is ejected, only one waveform is used, and the frequency problems encountered in DSS may be avoided. This is particularly advantageous in the offset solid ink printing process, as the drops are jetted in molten form onto a non-porous intermediate transfer surface where they have a finite time to coalesce and solidify. The multitude of smaller drops can be combined to form large drops of various color and/or shape on the intermediate substrate that are then transferred to a sheet of media.

In view of at least the forgoing, it is beneficial to provide a system for increasing the quality of a marked image including a controller. The controller may determine a marking pattern based on an input image signal, the marking pattern containing at least two sizes of marks and may eject single sized drops of marking material corresponding to a smallest one of the at least two sizes of marks on an intermediate substrate such that at least two of the single sized drops of marking material coalesce on the intermediate substrate to form another of the at least two sizes of marks.

It is beneficial to provide a method for increasing the quality of a marked image. The method may include steps of determining a marking pattern based on an input image signal, the marking pattern containing at least two sizes of marks, and ejecting single sized drops of marking material corresponding to a smallest one of the at least two sizes of marks on an intermediate substrate such that at least two of the single sized drops of marking material coalesce on the intermediate substrate to form another of the at least two sizes of marks.

It is beneficial to provide a storage medium storing a set of program instructions executable by a data processing device and usable to increase the quality of a marked image. The instructions may include instructions for determining a marking pattern based on an input image signal, the marking pattern containing at least two sizes of marks, and instructions for ejecting single sized drops of marking material corresponding to a smallest one of the at least two sizes of marks on an intermediate substrate such that at least two of the single sized drops of marking material coalesce on the intermediate substrate to form another of the at least two sizes of marks.

### BRIEF DESCRIPTION OF THE DRAWINGS

Exemplary embodiments of the invention will now be described with reference to the accompanying drawings, wherein:

FIG. 1 shows an exemplary marking device;

FIG. 2 shows exemplary marking material ejection patterns according to the exemplary systems and methods described herein; and

FIG. 3 shows an exemplary marking material ejection method.

### DETAILED DESCRIPTION OF EXEMPLARY IMPLEMENTATIONS

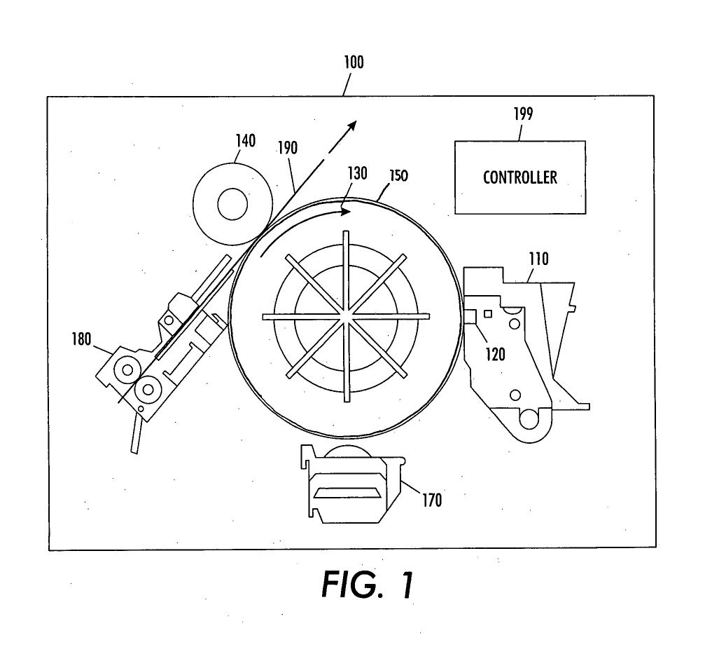

For a general understanding of a marking device utilizing an intermediate substrate, such as, for example, a solid inkjet printer, in which the exemplary systems and methods described herein may be incorporated, reference is made to FIG. 1. Although the various exemplary systems and methods described herein are particularly well adapted for use in such a device, it should be appreciated that the following exemplary implementations are merely illustrative. Rather, aspects of the various exemplary implementations may be achieved in any marking device containing at least one inkjet intended to transfer an image onto an intermediate substrate, prior to a sheet of media.

As shown in FIG. 1, the exemplary inkjet device 100 may include, in part, a print head 110, one or more inkjets 120, an intermediate transfer substrate (intermediate transfer surface on drum 130), a transfer roller 140, a drum maintenance unit 170, a media pre-heater 180 that constitutes a portion of the media feed path, and a controller 199. Under the control of the controller 199, the inkjets 120 may deposit marking material on the intermediate transfer surface on drum 130 to form an image. The intermediate transfer surface supported by drum 130 may consist of a thin liquid layer of, for example, silicone oil 150. The oil 150, may prevent marking material from adhering to the intermediate transfer surface on drum 130 and may aid in the transfer of the marking material from the intermediate transfer surface on drum 130 to a sheet of media 190. The oil 150 may be deposited on the intermediate transfer surface on drum 130, under control of the controller 199, by, for example, the drum maintenance unit 170. While the marking material is being deposited on the intermediate transfer surface supported by drum 130, the transfer roller 140 may not be in contact with the intermediate transfer surface 130.

Once an image or images have been marked on the intermediate transfer surface on drum 130, under the control of the controller 199, the exemplary inkjet device transfers the image or images from the intermediate transfer surface on drum 130 onto a sheet of media 190. Accordingly, a sheet of media 190 may be transported through the media pre-heater 180, under the control of the controller 199, to a position adjacent to and in contact with the intermediate transfer surface on drum 130. When the sheet of media 190 contacts the intermediate transfer surface on drum 130, the transfer roller 140 may be re-positioned, under the control of the controller 199, to apply pressure on the back side of the media in order to press the media against the intermediate transfer surface on drum 130. The pressure created by the transfer roller 140 on the backside of the sheet of media 190 facilitates the transfer of the marked image from the intermediate transfer surface on drum 130 onto the sheet of media 190.

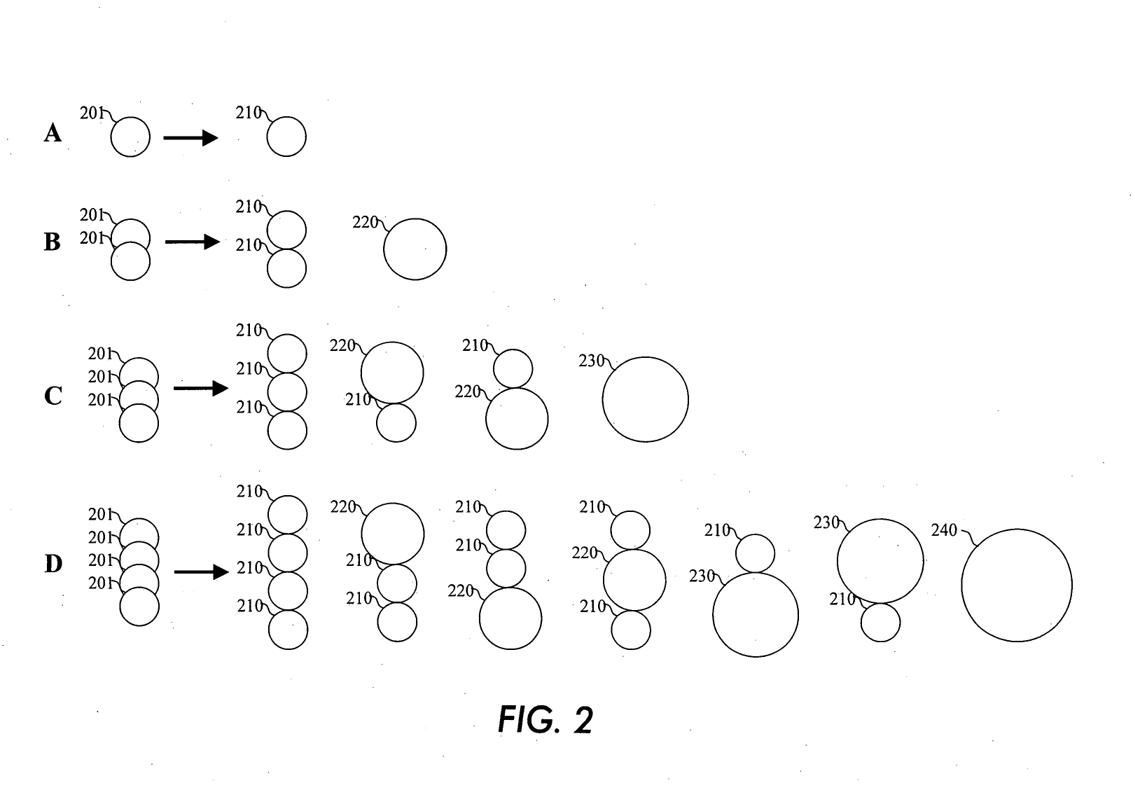

Due to the rotation of the intermediate transfer surface on drum 130 and the transfer roller 140 (shown by arrows in FIG. 1), the image or images on the intermediate transfer surface on drum 130 is/are transferred onto the sheet of media 190 while the sheet of media 190 is transported through the exemplary inkjet device 100 (in a direction shown by an arrow in FIG. 2).

As discussed above, the marking material is jetted onto the intermediate transfer surface supported by drum 130, prior to being transferred to a sheet of media 190. Thus, two or more drops of marking material that are jetted close to one another may coalesce on the intermediate transfer surface on drum 130 to form a larger drop. Although, as discussed above, it is difficult to vary drop mass utilizing a single jet, it is relatively simple to control the placement of drops by varying the speed, timing, and/or trajectory of the drop. For example, variations in jet timing (jitter) and/or the voltage (norm click or rail voltage) applied to a jet may be used to control the placement of a drop.

Numerous methods may be employed to control the placement of drops in a direction perpendicular to the travel of the printhead 110 relative to the intermediate transfer surface on drum 130 (hereinafter the x-direction). For example, small timing delays (jitter) can change the timing of the firing of a jet. Also, the voltage magnitude and/or shape may change the velocity of a drop. All are capable of changing the position of a drop on the intermediate transfer surface on drum 130 in a direction of rotation of the intermediate transfer surface on drum 130 (hereinafter the y-direction). The voltage and/or timing variations can result in the control of the placement of the drops in the y-direction depending on the rotation of the drum and the relative motion of the printhead with respect to the drum.

If relatively small single mass (i.e., one size) drops are jetted at a high frequency, the drops are already very close to each other and even small variations in timing, speed, and/or trajectory may result in the drops coalescing or remaining separated. Coalesced drops of a single size will result in larger drops having a size that is a multiple of the original small drop size. Accordingly, although only a single sized drop is ejected from the inkjets 120, multiple sized drops may be formed on the intermediate transfer surface on drum 130.

This principle will be described in greater detail with reference to FIG. 2. FIG. 2 shows some exemplary patterns that may be achieved according to the principles described herein. For ease of explanation, FIG. 2 only shows the variations in pattern in as a result of varying drop placement in a single direction Y. However, the same principles may be applied to variations in two directions.

As stated above, single mass drops 201 are jetted from the inkjets 120. Row A, in FIG. 2, shows an exemplary pattern that result from jetting a single drop 201 on the intermediate transfer surface on drum 130. The single drop 201 results in a marked area 210 equivalent to the single drop 201 on the intermediate transfer surface on drum 130. It should be appreciated that, although the drop patterns are shown in FIG. 2 a circular, the actual drop patterns may vary due to any number of factors, including, for example, imperfections on the intermediate transfer surface on drum 130, the trajectory of the drop, and the impact of the drop on the intermediate transfer surface on drum 130.

Row B, in FIG. 2, shows the patterns that may result from jetting two drops 201 on the intermediate transfer surface on drum 130. If the locations of the drops 201 are controlled such that the drops 201 remain separated, the drops 201 may result in two distinct marked areas 210 on the intermediate transfer surface on drum 130, each equivalent to the ejected drops 201. If the location of the drops 201 is controlled such that the drops 201 coalesce, the drops 201 may form a single larger marked area 220 on the intermediate transfer surface on drum 130, approximating that of a drop twice the size of the ejected drops 201.

Row C, in FIG. 2, shows the patterns that may result from jetting three drops 201 on the intermediate transfer surface on drum 130. If the locations of the drops 201 are controlled such that the drops 201 remain separated, the drops 201 may result in three distinct marked areas 210 on the intermediate transfer surface on drum 130, each equivalent to the ejected drops 201. If the locations of the first two drops 201 are controlled such that the first two drops 201 coalesce and the location of the third drop is controlled such that it remains separated, the first two drops 201 may form a single larger marked area 220 on the intermediate transfer surface on drum 130, approximating that of a drop twice the size of the ejected drops 201. The third drop 201 may result in a distinct marked area 210 on the intermediate transfer surface on drum 130 equivalent to the ejected drops 201.

If the locations of the second two drops 201 in row B of FIG. 2 are controlled such that the second two drops 201 coalesce and the location of the first drop is controlled such that it remains separated, the second two drops 201 may form a single larger marked area 220 on the intermediate transfer surface on drum 130, approximating that of a drop twice the size of the ejected drops 201. The first drop 201 may result in a distinct marked area 210 on the intermediate transfer surface on drum 130 equivalent to the ejected drops 201.

If the locations of all three drops 201 in row B of FIG. 2 are controlled such that all three drops 201 coalesce, the three drops 201 may form a single larger marked area 230 on the intermediate transfer surface on drum 130, approximating that of a drop three times the size of the ejected drops 201.

Row D, in FIG. 2, shows the patterns that may result from jetting four drops 201 on the intermediate transfer surface on drum 130. If the locations of the four drops 201 are controlled such that the drops 201 remain separated, the drops 201 may result in four distinct marked areas 210 on the intermediate transfer surface on drum 130, each equivalent to the ejected drops 201. If the locations of the first two drops 201 are controlled such that the first two drops 201 coalesce and the locations of the second two drops 201 are controlled such that the second two drops 201 remain separated, the first two drops 201 may form a single larger marked area 220 on the intermediate transfer surface on drum 130, approximating that of a drop twice the size of the ejected drops 201. The second two drops 201 may result in distinct marked areas 210 on the intermediate transfer surface on drum 130, each equivalent to the ejected drops 201.

If the locations of the second two drops 201 are controlled such that the second two drops 201 coalesce and the locations of the first two drops 201 are controlled such that the first two drops 201 remain separated, the second two drops 201 may form a single larger marked area 220 on the intermediate transfer surface on drum 130, approximating that of a drop twice the size of the ejected drops 201. The first two drops 201 will result in distinct marked areas 210 on the intermediate transfer surface on drum 130, each equivalent to the ejected drops 201.

If the locations of the second and third drops 201 are controlled such that the second and third drops 201 coalesce and the locations of the first and fourth drops 201 are controlled such that the first and fourth drops 201 remain separated, the second and third drops 201 may form a single larger marked area 220 on the intermediate transfer surface on drum 130, approximating that of a drop twice the size of the ejected drops 201. The first and fourth drops 201 may result in distinct marked areas 210 on the intermediate transfer surface on drum 130, each equivalent to the ejected drops 201.

The locations of the first two drops 201 may be controlled such that the first two drops 201 coalesce and the locations of the second two drops 201 may be controlled such that the second two drops 201 coalesce, with the fist two drops remaining separated from the second two drops. In this case, the first two drops 201 may form a single larger marked area 220 on the intermediate transfer surface on drum 130, approximating that of a drop twice the size of the ejected drops 201. The second two drops 201 may form a single larger marked area 220 on the intermediate transfer surface on drum 130, approximating that of a drop twice the size of the ejected drops 201.

If the locations of the first three drops 201 are controlled such that the first three drops 201 coalesce and the location of the fourth drop 201 is controlled such that the fourth drop 201 remains separated, the first three drops 201 may form a single larger marked area 220 on the intermediate transfer surface on drum 130, approximating that of a drop three times the size of the ejected drops 201. The fourth drop 201 may result in a distinct marked area 210 on the intermediate transfer surface on drum 130 equivalent to the ejected drops 201.

If the location of the first drop 201 is controlled such that the first drop 201 remains separated and the locations of the remaining three drops 201 are controlled such that the remaining drops 201 coalesce, the first drop 201 may result in a distinct marked area 210 on the intermediate transfer surface on drum 130 equivalent to the ejected drops 201. The remaining three drops 201 may form a single larger marked area 220 on the intermediate transfer surface on drum 130, approximating that of a drop three times the size of the ejected drops 201.

If the locations of all four drops 201 are controlled such that the four drops 201 coalesce, the four drops 201 will may a single larger marked area 220 on the intermediate transfer surface on drum 130, approximating that of a drop four times the size of the ejected drops 201.

It should be appreciated that similar patterns may be achieved with five or more drops 201. However, device limitations, such as the maximum distance over which the placement of a drop may be controlled and, marking limitations, such as image defects that may result from overly large drop sizes may influence the maximum number of drops that may be coalesced in certain marking devices.

As described above, by coalescing substantially same sized drops on the intermediate transfer surface on drum 130, single mass drops may be ejected while multiple size drops may be utilized in marking an image. The utilization of these multiple size drops at least provides varied resolution within a single image; for example, in order to use large drops in solid fill regions to increase color saturation and to use small drops in light fill regions to reduce graininess. Furthermore, the utilization of larger drops formed on the intermediate transfer surface on drum 130 at least prevents the problems associated with dual-drop printing, such as, for example, waveform size discrepancy. The utilization of small drops allows for increased image resolution and the high frequency with which drops may be ejected, due in part to the use of a single waveform, may increase overall marking speed.

It should be appreciated that the above-described principles are particularly advantageous when applied to colored marking material. By allowing marking material drops of different colors to coalesce, the individual drops of different colored marking material may mix to form a larger drop of marking material having a color resulting from the mixture of the original jetted drops. The mixture of jetted drops is advantageous in at least two respects. First, a drop of marking material having a color different than that of the jetted making material may be created on the intermediate transfer surface on drum 130, thereby expanding the available colors of marking material far beyond those of actually jetted. Second, the use of substantially transparent marking material may enable the lightening of marking material

Conventionally, colored marking devices utilize a fixed number of colored marking materials in order to create colored images. For example, many color solid inkjet devices use cyan, magenta, yellow, and black, commonly referred to as “CMYK.” In order to create colors other than cyan, magenta, yellow, and black, these devices mark at least two colors of the four available colors close to one another. For example, in order to create a green area, such a device may mark very small alternating areas of cyan and yellow. The individual areas of different color, commonly referred to as “pixels” or “dots,” may be marked relatively small such that they are substantially invisible to the naked eye. The overall effect of this pixilated printing is the ability to approximate colors other than cyan, magenta, yellow, and black. However, by virtue of, for example, the limited colors of the marking material, the size of the pixels, and various patterns of pixels that will remain substantially invisible to the naked eye, the range of colors reproduced by the device, commonly referred to as its “gamut,” is limited.

According to the principles described herein, marking material of different colors may be mixed in its liquid form by coalescing drops on the intermediate transfer surface on drum 130. Accordingly, rather than two drops of cyan and yellow marked adjacent to one another and intended to approximate a green drop, a drop of cyan marking material and a drop of yellow marking material may be jetted on to the intermediate transfer surface on drum 130 such that they coalesce into a larger drop of green (e.g., drop 220 in FIG. 2). The coalescence causes the marking material to mix within the larger drop. Because the larger drop of green will be transferred to the sheet of media 190, a viewer will actually see green rather than an appearance of green created by pixels of cyan and yellow marked very close together.

Conventional color marking material devices, such as, for example, a color solid inkjet printer, approximate lighter shades of color by spacing out drops of colored marking material on a white, or otherwise lightly colored, sheet of media. By allowing an amount of the lighter sheet of media to be exposed, the visual effect approximates a lighter shade of the color(s) jetted onto the sheet of media. However, as the approximated shades become lighter, the distance between the marked areas increases in order to allow more of the lighter sheet of media to be exposed. As the distance between the marked areas increases, the individual marked areas become more visible to the naked eye resulting in a grainy marked image, and the effectiveness of the approximation is reduced.

According to the principles described herein, substantially transparent (hereinafter transparent) marking material may be mixed with colored marking material to lighten the shade of the colored marking material by coalescing at least one drop of the transparent marking material with colored marking material on the intermediate transfer surface on drum 130. Accordingly, for example, a drop of cyan marking material and a drop of transparent marking material may be jetted on to the intermediate transfer surface on drum 130 such that they coalesce into a larger drop of lighter cyan (e.g., drop 220 in FIG. 2). Because the larger drop of lighter cyan will be transferred to the sheet of media 190, a viewer will actually see light cyan rather than an appearance of light cyan created by spaced apart pixels of cyan. Furthermore, the lighter shades of color marking material, created by coalescing small drops of colored marking material with small drops of transparent marking material, may be marked on the drum substantially adjacent to one another, such that lighter shade is substantially continuous rater than spaced apart.

It should be appreciated that for the sake of simplicity the above-described examples describe mixing only two colors of marking material or a single color of marking material with transparent marking material. According to the above-described principles, any number of colors of marking material may be mixed on the intermediate transfer surface on drum 130 by coalescence, including transparent marking material. Accordingly, the number of hues and shades of color that may be mixed on the intermediate transfer surface on drum 130 due to coalescence is much greater. Similarly, the overall gamut of a device utilizing the above-described principles is much larger than those of the conventional color marking devices.

As discussed above with respect to FIG. 1, the exemplary inkjet device 100 may utilize a layer of oil 150 or other similar substance on the intermediate transfer surface on drum 130. This layer of oil 150, among other things, helps prevents marking material that is jetted on the intermediate transfer surface on drum 130 from adhering to the intermediate transfer drumintermediate transfer surface on drum 130 or from being drawn into any imperfections on the surface of the intermediate transfer surface on drum 130. By virtue of, for example, the hydrophobic nature of the oil, the viscosity of the marking material, and the surface tension of the marking material, drops of the marking material tend to bead on the layer of oil 150 and thus are easily transferred to a sheet of media.

The beaded nature of the marking material, aided in part by the presence of the oil 150, is particularly advantageous to the principles described herein. Because the marking material is beaded, when two or more drops are jetted adjacent to one another, the beads provide a large surface area for the drops to contact and coalesce. If the marking material formed a more flattened, puddle-like structure, the drops might not coalesce, or only partially coalesce, thereby hindering the mixture of the marking material to create different hues and or shades.

In view of the forgoing, it should be appreciated that the layer of oil 150 is not necessary. The principles described herein are applicable to marking material jetted directly onto the intermediate transfer surface on drum 130

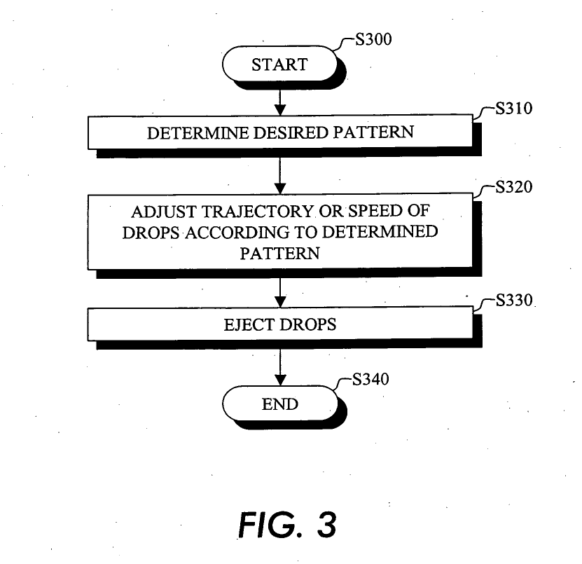

FIG. 3 shows an exemplary marking material ejection method that may utilize the principles described herein. The method begins in step S300 and continues to step S310. In step S310, a desired print pattern for an image is determined. For example, a data signal representing the image may be input into a marking device. Based on the input image signal, for example, a controller may determine the pattern of marking material drops, including drops of different sizes and/or drops of varying hue and shade, to eject. Operation of the method continues to step 320.

In step S320, the trajectory, speed, and/or timing of single sized drops may be adjusted according to the determined pattern such that the drops, which according to the determined pattern should coalesce, are likely to coalesce. Then, in step S330, the drops are ejected. In step S340, operation of the method ends.

It should be appreciated that the above-described exemplary method may be performed for an entire image, or may be looped for sections of an entire image. Additionally, the desired pattern may be determined for an entire image (step S310), while the positional adjustment of the drops and ejection of the drops (steps S320 and S330) may be looped for sections of the image.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

1. A system for increasing the quality of a marked image, comprising:
a controller that:
determines a marking pattern based on an input image signal, the marking pattern containing at least two sizes of marks; and
ejects single sized drops of marking material corresponding to a smallest one of the at least two sizes of marks on an intermediate substrate such that at least two of the single sized drops of marking material coalesce on the intermediate substrate to form another of the at least two sizes of marks.

2. The system of claim 1, wherein the controller adjusts at least one of the speed, timing, or trajectory of an ejected single sized drop in order to cause that single sized drop to coalesce with another single sized drop on the intermediate substrate.

3. The system of claim 1, further comprising the intermediate substrate, the intermediate substrate comprising a layer of oil.

4. The system of claim 1, wherein:
the marking pattern contains a hue other than that of the marking material; and
the controller ejects the single sized drops of marking material corresponding to the smallest one of the at least two sizes of marks on the intermediate substrate such that at least two of the single sized drops of marking material coalesce on the intermediate substrate to form a mark substantially corresponding to the hue.

5. The system of claim 4, wherein the marking material comprises:
cyan marking material;
magenta marking material;
yellow marking material; and
black marking material.

6. The system of claim 1, wherein:
the marking pattern contains a shade other than that of the marking material; and
the controller ejects the single sized drops of marking material corresponding to the smallest one of the at least two sizes of marks on the intermediate substrate such that at least two of the single sized drops of marking material coalesce on the intermediate substrate to form a mark substantially corresponding to the shade.

7. The system of claim 6, wherein the marking material comprises at least one of:
substantially transparent marking material; and
substantially translucent marking material.

8. The system of claim 1, wherein the system is incorporated into a solid inkjet printer.

9. The system of claim 1, wherein the controller controls the placement of the single sized drops of marking material in a y-direction, the y-direction substantially parallel to a direction of rotation of the intermediate substrate.

10. The system of claim 1, wherein the controller controls the placement of the single sized drops of marking material in an x-direction, the x-direction substantially perpendicular to a direction of rotation of the intermediate substrate.

11. A method for increasing the quality of a marked image, comprising:
determining a marking pattern based on an input image signal, the marking pattern containing at least two sizes of marks; and
ejecting single sized drops of marking material corresponding to a smallest one of the at least two sizes of marks on an intermediate substrate such that at least two of the single sized drops of marking material coalesce on the intermediate substrate to form another of the at least two sizes of marks.

12. The method of claim 11, further comprising:
adjusting at least one of the speed, timing, or trajectory of an ejected single sized drop in order to cause that single sized drop to coalesce with another single sized drop on the intermediate substrate.

13. The method of claim 11, wherein:
ejecting the single sized drops of marking material comprises ejecting the single sized drops of marking material corresponding to the smallest one of the at least two sizes of marks on the intermediate, the intermediate substrate comprising a layer of oil.

14. The method of claim 11, wherein:
the marking pattern contains a hue other than that of the marking material; and
ejecting the single sized drops of marking material comprises the single sized drops of marking material corresponding to the smallest one of the at least two sizes of marks on the intermediate substrate such that at least two of the single sized drops of marking material coalesce on the intermediate substrate to form a mark substantially corresponding to the hue.

15. The method of claim 14, wherein ejecting the single sized drops of marking material comprises ejecting at least one of:
cyan marking material;
magenta marking material;
yellow marking material; and
black marking material.

16. The method of claim 11, wherein:
the marking pattern contains a shade other than that of the marking material; and
ejecting the single sized drops of marking material comprises ejecting the single sized drops of marking material corresponding to the smallest one of the at least two sizes of marks on the intermediate substrate such that at least two of the single sized drops of marking material coalesce on the intermediate substrate to form a mark substantially corresponding to the shade.

17. The method of claim 16, wherein ejecting the single sized drops of marking material comprises ejecting at least one of:
substantially transparent marking material; and
substantially translucent marking material.

18. The method of claim 11, ejecting the single sized drops of marking material comprises ejecting the single sized drops of marking material from an inkjet in a solid inkjet printer.

19. The method of claim 11, further comprising controlling the placement of the single sized drops of marking material in a y-direction, the y-direction substantially parallel to a direction of rotation of the intermediate substrate.

20. The method of claim 11, further comprising controlling the placement of the single sized drops of marking material in an x-direction, the x-direction substantially perpendicular to a direction of rotation of the intermediate substrate.

21. A storage medium storing a set of program instructions executable by a data processing device and usable to increase the quality of a marked image, the instructions comprising:
instructions for determining a marking pattern based on an input image signal, the marking pattern containing at least two sizes of marks; and
instructions for ejecting single sized drops of marking material corresponding to a smallest one of the at least two sizes of marks on an intermediate substrate such that at least two of the single sized drops of marking material coalesce on the intermediate substrate to form another of the at least two sizes of marks.
